(19) United States
(12) Patent Application Publication
(10) Pub. No.: US 2005/0097020 A1
(43) Pub. Date: May 5, 2005

(54) Service providing apparatus, control processor and service providing method

(76) Inventors: Takuji Nomura, Kanagawa (JP); Takezo Fujishige, Kanagawa (JP); Kiyoshi Kasatani, Kanagawa (JP)

Correspondence Address: MORRISON & FOERSTER LLP, 1650 TYSONS BOULEVARD, SUITE 300, MCLEAN, VA, 22102, US

(21) Appl. No.: 10/957,740

(22) Filed: Oct. 5, 2004

(30) Foreign Application Priority Data
Oct. 10, 2003 (JP) 2003-352243

(51) Int. Cl. G03G 21/16; G06F 17/60

(52) U.S. Cl. 705/35; 705/26

(57) ABSTRACT

A service providing apparatus includes an operating part that receives a usage request from outside. A sending part sends the usage request to a control processor via a network. A receiving part receives usage permission corresponding to the usage request from the control apparatus via the network. A service process part is enabled based on the usage permission and disabled upon reception of a predetermined end instruction.

### BACKGROUND OF THE INVENTION

1. Field of the Invention

The present invention generally relates to service providing apparatuses used by users by paying fees, control processors performing control thereof, and service providing methods.

2. Description of the Related Art

A copying apparatus, which is a service providing apparatus, is installed in, for example, a convenience store or a document service store and offers users copying services of copying manuscripts for a fee. An advantage of such copying services is in that users who do not own copying apparatuses and users who have only printers for personal computers can use a copying apparatus installed in a convenience store or a document service store in their neighborhoods to output copies. In addition, generally, payment for such copying services is made by an accounting device such as a coin rack or a money handling device provided in the vicinity of the copying apparatus.

When a user uses a copying apparatus, it is possible for the user to use the copying apparatus by inserting one or more coins in the money handling device. Then, the user performs various settings by using an operating part of the copying apparatus, for example: the number of copies and whether to perform black and white copying or color copying. By pressing a start button, copying is started. On this occasion, the user has to make payment of the fee determined by the various settings such as the number of copies and whether to perform black and white copying or color copying. That is, every time a copy is delivered from the copying apparatus, the money handling device collects the fee from the coins and/or bills inserted into the money handling device.

In the aforementioned manner, generally, fees are collected from users by an accounting apparatus such as a money handling device without a mediator such as a salesperson of a convenience store or a document service store (refer to Japanese Laid-Open Patent Application No. 2002-214988, for example).

As mentioned above, conventional service providing apparatuses such as copying apparatuses collect fees from users by, for example, money handling devices. However, it is necessary for salespersons or service persons to regularly collect and count accumulated coins and/or bills in money handling devices, which is a burden on the salespersons or service persons.

Additionally, in the case where fees are collected by a money handling device upon usage of a service providing apparatus, it is necessary for a user to confirm in advance the amount of money in possession and an estimated amount of payment based on the service the user requests (for example, the size of paper and the type of copying such as black and white or color). Thus, when the amount of money in possession is not enough for the service, the user cannot fully enjoy the service.

In addition, when a user has no coins and wishes to use a money handling device accepting only coins, the user asks a salesperson of a convenience store or the like to exchange money. However, in the interests of crime prevention, some shops do not offer money exchange. Also in this case, the user cannot enjoy the service.

Further, in the case where, for example, an employee of a company charges the company for using a service providing apparatus in a convenience store or the like, it is necessary for the employee to ask a salesperson of the convenience store to write a receipt, which results in a burden on the convenience store.

### SUMMARY OF THE INVENTION

A general object of the present invention is to provide an improved and useful service providing apparatus, control processor, and service providing method in which one or more of the above-mentioned problems are eliminated.

Another and more specific object of the present invention is to remotely control whether to allow a user to use a service providing apparatus.

Still another object of the present invention is to charge a user without actually paying and receiving money (cash) when the user uses a service providing apparatus.

Yet another object of the present invention is to simply identify a user when the user uses a service providing apparatus.

In order to achieve the above-mentioned objects, according to one aspect of the present invention, there is provided a service providing apparatus including:
an operating part that receives usage request from outside;
a sending part that sends the usage request to a control processor via a network;
a receiving part that receives usage permission corresponding to the usage request from the control apparatus via the network; and
a service process part that is enabled based on the usage permission and disabled upon reception of a predetermined end instruction.

Additionally, according to another aspect of the present invention, there is provided a control processor including:
a receiving part that receives a usage request from a service providing apparatus via a network;
a checking part that issues usage permission corresponding to the usage request; and
a sending part that sends the usage permission to the service providing apparatus via the network.

Additionally, according to another aspect of the present invention, there is provided a service providing method of providing a service to a user by controlling a service providing apparatus, the method including the steps of:
receiving one of a usage request and an end instruction from outside;
sending the usage request to a control processor via a network;
receiving usage permission from the control processor via the network; and
allowing use of the service providing apparatus based on the usage permission and making use of the service providing apparatus impossible based on the end instruction.

The present invention achieves, for example, the effects as follows.

It is possible to easily and remotely control whether to allow use of the service providing apparatus.

In addition, it becomes unnecessary to actually pay and receive money (cash) when the user uses the service providing apparatus. Also, it is possible for the user to use the service providing apparatus without caring of money in possession.

Further, it is to possible to easily identify a user when the user uses the service providing apparatus.

Other objects, features and advantages of the present invention will become more apparent from the following detailed description when read in conjunction with the following drawings.

### BRIEF DESCRIPTION OF THE DRAWINGS

FIG. 1 is a block diagram of a service providing system according to a first embodiment of the present invention;

FIG. 2 is a block diagram of a service providing apparatus;

FIG. 3 is a block diagram of a control processor according to the first embodiment of the present invention;

FIG. 4 shows tables for explaining items of databases according to the first embodiment of the present invention;

FIG. 5 is a flowchart for explaining a user registration process;

FIG. 6 is a sequence diagram showing operations for providing a service according to the first embodiment of the present invention;

FIG. 7 is a continuation of the sequence diagram of FIG. 6, showing operations for providing the service according to the first embodiment of the present invention;

FIG. 8 is a schematic diagram showing a screen for inputting a user ID and the like;

FIG. 9 is a schematic diagram showing a screen displaying a charged amount of money;

FIG. 10 is a block diagram showing a service providing system according to a second embodiment of the present invention;

FIG. 11 is a block diagram showing a control processor according to the second embodiment of the present invention;

FIG. 12 shows a table for explaining items of a database according to the second embodiment of the present invention;

FIG. 13 is a sequence diagram showing operations for providing a service according to the second embodiment of the present invention;

FIG. 14 is a continuation of the sequence diagram of FIG. 13, showing operations for providing the service according to the second embodiment of the present invention;

FIG. 15 is a continuation of the sequence diagram of FIG. 14, showing operations for providing the service according to the second embodiment of the present invention;

FIG. 16 is a schematic diagram showing a screen for inputting a user ID and the like;

FIG. 17 is a schematic diagram showing a screen for displaying a right ID; and

FIG. 18 is a schematic diagram showing a screen for inputting the right ID.

### DETAILED DESCRIPTION OF THE PREFERRED EMBODIMENTS

A description is given below of embodiments of the present invention, with reference to the drawings.

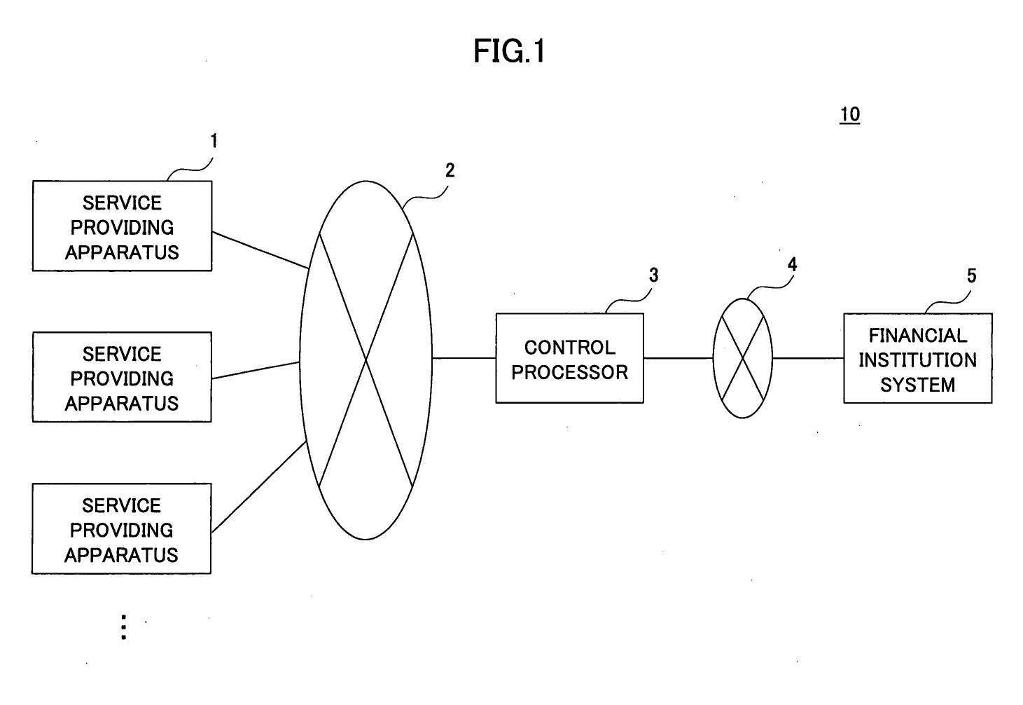

FIG. 1 is a block diagram of a service providing system 10 according to a first embodiment of the present invention.

Referring to FIG. 1, in the service providing system 10, plural service providing apparatuses 1 installed in, for example, a convenience store are connected via a network 2 to a control processor 3 that determines whether it is possible to use the service providing apparatuses 1 and manages accounting information for each user.

The control processor 3 is connected to a financial institution system 5 via a network 4, and thus an administrator (hereinafter referred to as “the accounting service provider”) administering the control processor 3 can perform a credit operation and/or paying and receiving of money between a user and a financial institution specified by the user. Here, the financial instrument represents an organization that mediates financial transactions and includes, in Japan, the Bank of Japan, commercial banks, long-term credit banks, trust banks, cooperative banks, credit associations, agricultural cooperatives, fishermen's unions, insurance companies, securities companies, nonbank credit institutions, post offices, credit card companies, and telecommunications companies. It should be noted that the networks 2 and 4 may be public circuits and/or dedicated lines, and the communication methods thereof may be wireless and/or wired. The same applies to other embodiments.

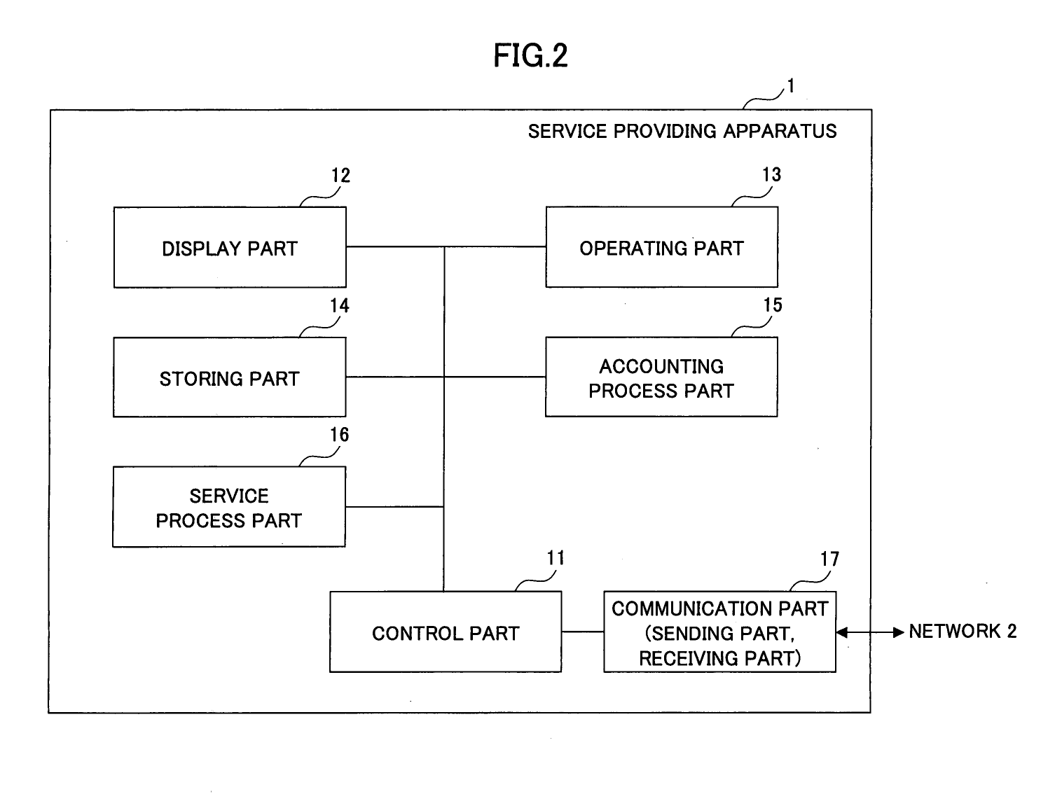

FIG. 2 is a block diagram of one of the service providing apparatuses 1.

Referring to FIG. 2, the service providing apparatus 1 includes a control part 11, a display part 12, an operating part 13, a storing part 14, an accounting process part 15, a service process part 16 and a communication part 17.

The control part 11 includes a function to control processes performed by the service providing apparatus 1.

The display part 12 includes a function to be used for displaying various information items to a user. In the case where, for example, the service providing apparatus 1 is a copying apparatus, the display part 12 is a touch panel display and displays, for example: a soft button for selecting a paper size, a soft button for selecting magnification, a soft button for selecting a copying density, the number of copies, the selected paper size, the magnification and the copying density.

The operating part 13 includes a function used for receiving (inputting) a request from the user. In the case where, for example, the service providing apparatus 1 is a copying apparatus, the operating part 13 includes input functions used when the user requests a service from the copying apparatus, for example: a reset button for resetting the copying function to a standard mode, a start button for starting a copying process, a stop button for suspending the copying process, a ten-key pad used for setting the number of copies, and the soft buttons of the touch panel display of the above-mentioned display part 12. In addition, of course, the input functions are used also when inputting, for example, a user ID.

The storing part 14 is for storing data necessary for processing and stores: a network address uniquely assigned to each service providing apparatus 1; the address (control processor address) of the control processor 3, which is a communication party; and software necessary for operating the service providing apparatus 1. Additionally, the storing part 14 temporarily stores: identification information (job number) provided by the control processor 3; an amount of money charged, which is the value for the use of a service; and the content of processes (operations, services) performed in the service providing apparatus 1. Here, the content of processes indicates information representing the history of processes (operations, services) performed. In the case where, for example, the service providing apparatus 1 is a copying apparatus or a facsimile apparatus, the content of processes may be image data (or thumbnails) of the contents that are copied or subjected to facsimile transmission. In the case where, for example, the service providing apparatus 1 is a public phone, the content of processes may be the telephone number of a communication party.

The accounting process part 15 includes a function to calculate the value for providing the service to the user by the service providing apparatus 1 by referring to a table or an equation for calculating the fee that is set with respect to services, and add the calculated value to the amount of money charged, which is temporarily stored in the storing part 14. In the case where the service providing apparatus 1 is a copying apparatus, the accounting process part 15 performs an accounting process every time (or every time after) a service to be charged is performed in the copying apparatus. It should be noted that the table or the equation for calculating the fee for each service is set in advance in the accounting process part 15, or is dynamically set at an instruction to set the fee from the control processor 3.

Since the accounting process part 15 is provided inside the service providing apparatus 1 as mentioned above, it is possible to calculate the fee for service without communicating with the control processor 3 and quickly present the fee to the user. It should be noted that, when the service providing apparatus 1 is a facsimile apparatus, the accounting process part 15 performs an accounting process for each document subjected to facsimile transmission, and when the service providing apparatus 1 is a telephone, the accounting process part 15 performs the accounting process for each telephone call or each duration of call.

The service process part 16 includes a function to realize services provided by the service providing apparatus 1. Normally, the service process part 16 is locked (the use of the service process part 16 is limited). Upon receiving permission to perform charging (permission to use services) from the control processor 3, the lock is released (the limitation on the use of the service process part 16 is removed). Upon receiving an end instruction given from outside such as the user, the service process part 16 is locked again (the use of the service processing apparatus 16 is limited again). As mentioned above, it is impossible to use the service process part 16 without permission from the control processor 3, which prevents unauthorized use. The end instruction given from outside may be a predetermined end instruction, for example: an end instruction given by the user with the use of the operating part 13; an end instruction issued when an abnormality or unauthorized use is detected in the control part 11 provided in the service providing apparatus 1; or an end instruction remotely given from the control processor 3.

In the case where the service providing apparatus 1 is a copying apparatus, the service process part 16 has a function (copying process part) of realizing a copying function, which is a service provided by the copying apparatus, and the copying process part may be structured by a color reader and a color printer. As previously mentioned, the function of the service process part 16 differs depending on the services provided by the service providing apparatus 1. In the case where, for example, the service providing apparatus 1 is a facsimile apparatus, the service process part 16 is a process part provided with a facsimile function. In the case where, for example, the service providing apparatus 1 is a coin-operated locker, the service process part 16 is a process part provided with closing/opening functions of a door. In the case where, for example, the service providing apparatus 1 is a public phone, the service process part 16 is a process part provided with a telephone call function.

The communication part 17 is formed by a sending part and a receiving part, and includes functions (a sending function and a receiving function) to send various information items to and receive various information items from the control processor 3 via the network 2.

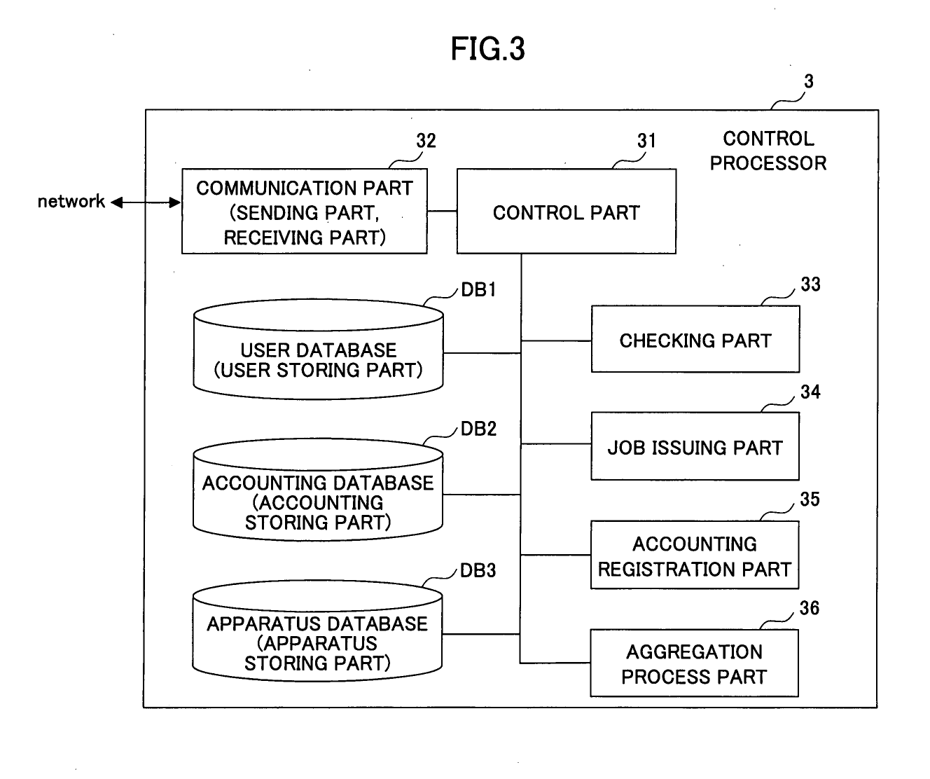

FIG. 3 is a block diagram of the control processor 3 in the first embodiment of the present invention.

Referring to FIG. 3, the control processor 3 includes a control part 31, a communication part 32, a checking part 33, a job issuing part 34, an accounting registration part 35, an aggregation process part 36, a user database DB1, an accounting database DB2, and an apparatus database DB3.

The control part 31 includes a function to control processes performed by the control processor 3.

The communication part 32 is formed by a sending part and a receiving part, and includes functions (a sending function and a receiving function) used for sending various information items to and receiving various information items from the service providing apparatuses 1 and the financial institution system 5 via the networks 2 and 4, respectively.

The checking part 33 determines whether to allow usage of the service providing apparatus 1 in accordance with a request for using the service providing apparatus 1 from the user, and issues an instruction indicating whether it is allowed to use the service providing apparatus 1. In a narrow sense, the checking part 33 includes a function to check users to be charged and the service providing apparatuses 1. More specifically, the checking part 33 performs, for example, the following processes.

(1) The checking part 33 performs processes of receiving an apparatus ID in information sent from the service providing apparatus 1, and referring to the apparatus database DB3, which stores in advance information related to the service providing apparatuses 1, to determine whether a corresponding apparatus ID exists. When the decision result is “YES” (when the corresponding apparatus ID exists), the process proceeds to the process (2). When the decision result is “NO” (when the corresponding apparatus ID does not exist), the checking part 33 notifies the control part 31 with “impermissible”. It should be noted that the checking of an apparatus ID is not always necessary. The checking of an apparatus ID is applied when it is determined in advance whether the service providing apparatus 1 is chargeable via the network 2.

(2) The checking part 33 performs processes of receiving “a user ID and a user PW (password) of a user” in the information sent from the service providing apparatus 1, and determining whether the received user ID and user PW match corresponding user ID and user PW stored in the user database DB1, which stores in advance user information with respect to users. When there is a match, the checking part 33 notifies the control part 31 with “permission to use (usage permission)”. When there is no match, the checking part 33 notifies the control part 31 with “usage not permitted”.

As mentioned above, since the checking part 33 is provided, it is possible to give an instruction to the service providing apparatus 1 that utilization thereof is permitted or not permitted, and to remotely control the service providing apparatus 1.

The job issuing part 34 includes a function to issue uniquely defined identification information (job number) within a predetermined period so that it is possible to charge the service providing apparatus 1, the use of which apparatus is permitted, for each operation (service). Here, the identification information (job number) is information for indicating differences between operations. The job issuing part 34 performs processes of notifying the control part 31 of the issued identification information and storing in the accounting database DB2 the identification information in association with the user ID and the apparatus ID. As mentioned above, since the job issuing part 34 issues uniquely defined identification information (job number), it is possible to charge a user for each operation (service). In addition, with identification information (job number), it is possible for the service providing apparatuses 1 and the control processor 3 to positively send and receive charged amounts of money to each other.

The accounting registration part 35 includes a function to record a charged amount of money received from the service providing apparatus 1 as accounting information. Specifically, the accounting registration part 35 performs processes of referring to the accounting database DB2 based on the identification information in information (for example, identification information, apparatus ID, charged amount of money, and content of processes) received from the service providing apparatus 1, and recording the charged amount of money to an item “charged amount of money” of accounting information associated with the corresponding identification information.

In addition, the accounting registration part 35 includes a function to record the content of processes (operations, services) performed in the service providing apparatus 1 in an item of “content of processes” associated with the corresponding identification information (job number). As mentioned above, with the use of identification information (job number), the accounting registration part 35 can accurately send and receive charged amounts of money between the service providing apparatuses 1 and the control processor 3 to charge for each operation (service).

The aggregation process part 36 includes a function that is used for aggregating information for a certain matter. In the case where, for example, the aggregation process part 36 is used with respect to the accounting database DB2, it is possible to aggregate amounts of money for each user by performing an aggregation process for each user (for each user ID), and it is also possible to aggregate amounts of money used for each service providing apparatus 1 by performing an aggregation process for each service providing apparatus 1. Although the aggregation process part 36 is not always necessary, the aggregation process part 36 is very beneficial in charging and paying money with respect to users and/or financial instruments at one time (in an aggregated manner). Particularly, in the cases where a user uses the service providing apparatus 1 at odd intervals and/or where payment for each usage of a service is a small amount of money, it is possible to charge, for example, financial instruments at one time (in an aggregated manner) by using the aggregation process part 36, which increases convenience.

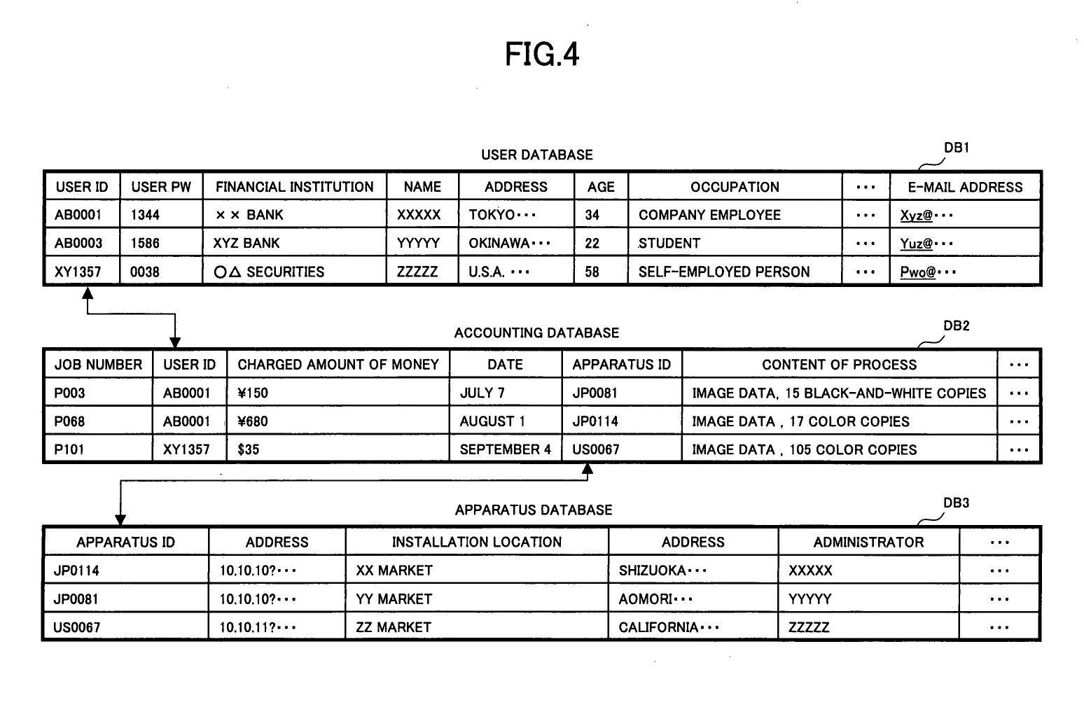

The user database DB1, which serves as a user storing part, stores user information related to users. As shown in FIG. 4, the user database DB1 includes items of at least user ID, user PW (password), and financial instruments via which fees are paid (for example, a transfer account). In addition to these, the user database DB1 may also include items of, for example, name, age, occupation, telephone number (fixed telephone), telephone number (mobile phone), and e-mail address.

The accounting database DB2, which serves as an accounting storing part, stores accounting information necessary for charging users. As shown in FIG. 4, the accounting database DB2 includes an item of at least charged amount of money. The accounting database DB2 may also include items of, for example, identification information (job number), user ID, date of use, apparatus ID, and content of processes. Here, the content of processes is an item representing the content of processes (operations, services) used in the service providing apparatus 1. In the case where, for example, the service providing apparatus 1 is a copying apparatus or a facsimile apparatus, the content of processes may be image data (or a thumbnail) of the contents subjected to copying or facsimile transmission, respectively. In the case where, for example, the service providing apparatus 1 is a public phone, the content of processes may be the telephone number of a communication party.

The apparatus database DB3, which serves as an apparatus storing part, stores apparatus-related information with respect to each service providing apparatus 1. As shown in FIG. 4, the apparatus database DB3 includes items of apparatus ID and network address (for example, IP address) of service providing apparatuses 1. The apparatus database DB3 may also include items of installation location, address of installation location, administrator, and emergency contact address.

Next, a description is given below of operations in the first embodiment of the present invention. It should be noted that the description is given by assuming that the service providing apparatus 1 is a copying apparatus and the service process part 16 is a copying process part.

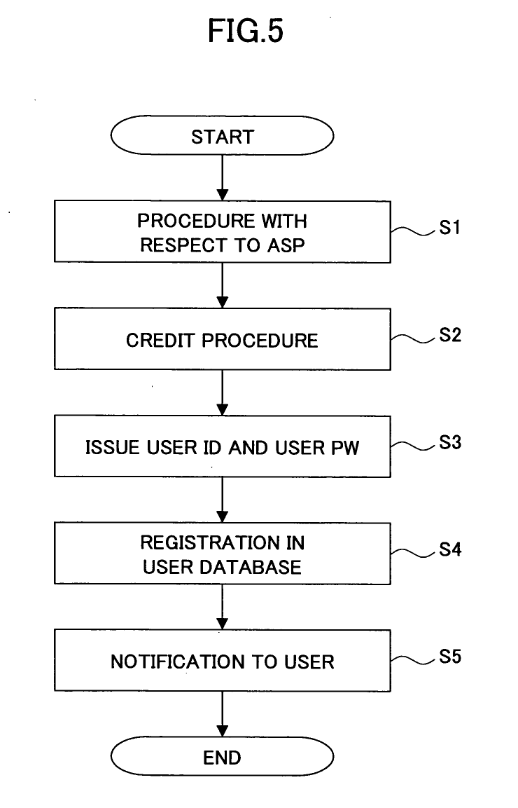

FIG. 5 is a flowchart for explaining processes of user registration.

Referring to FIG. 5, in step S1, a user carries out a procedure required by an accounting service provider (ASP) in advance so that the user is charged via a network when using the service providing apparatus 1. More specifically, with the use of communication means such as the Web, e-mail, telephone and mail, the user carries out the procedure by conveying user information required by the accounting service provider (ASP), for example: financial instrument via which fee is to be paid; address; name; age; occupation; telephone number (fixed telephone); telephone number (mobile phone) and e-mail address.

In step S2, the accounting service provider (ASP) that accepts the application asks the financial institution via which payment for fee is to be made for a credit examination of the user. When user credit approval is obtained from the financial institution, the accounting service provider performs the subsequent process.

In step S3, a unique pair of a user ID and a user PW is issued for each user by using the control processor 3 or another device.

In step S4, the above-mentioned user information is associated with the issued user ID and user PW, and stored in the user database DB1 of the control processor 3 as the user information.

In step S5, after the storing is completed, the user is informed of the user ID and the user PW via predetermined communication means (for example, the Web, e-mail, telephone or mail).

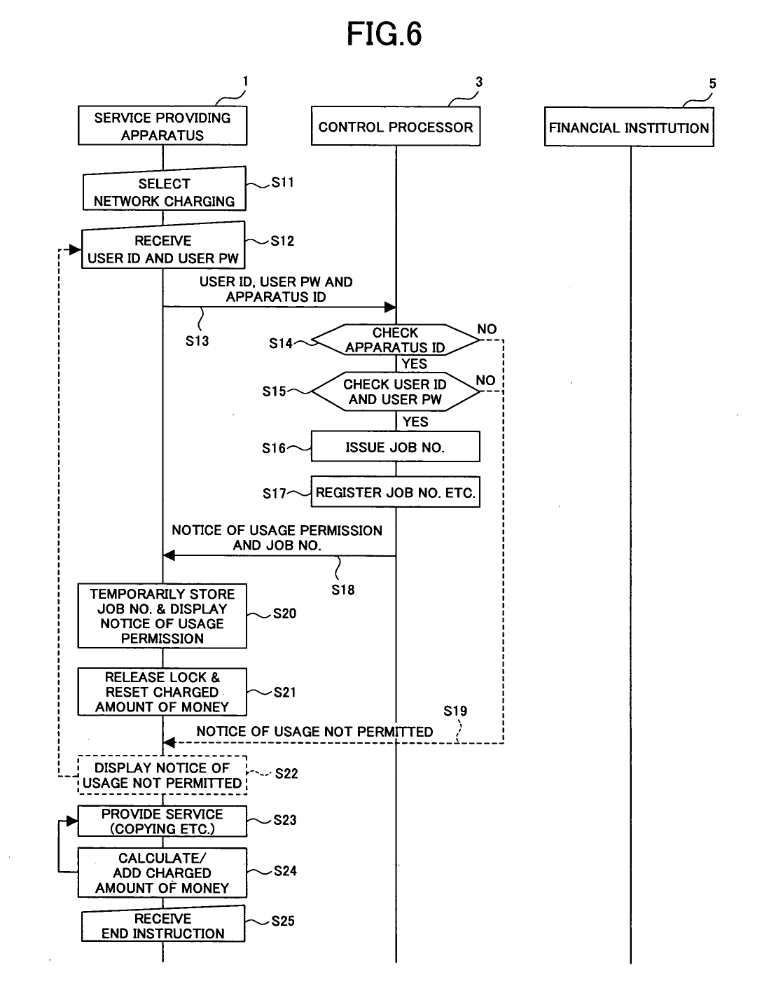

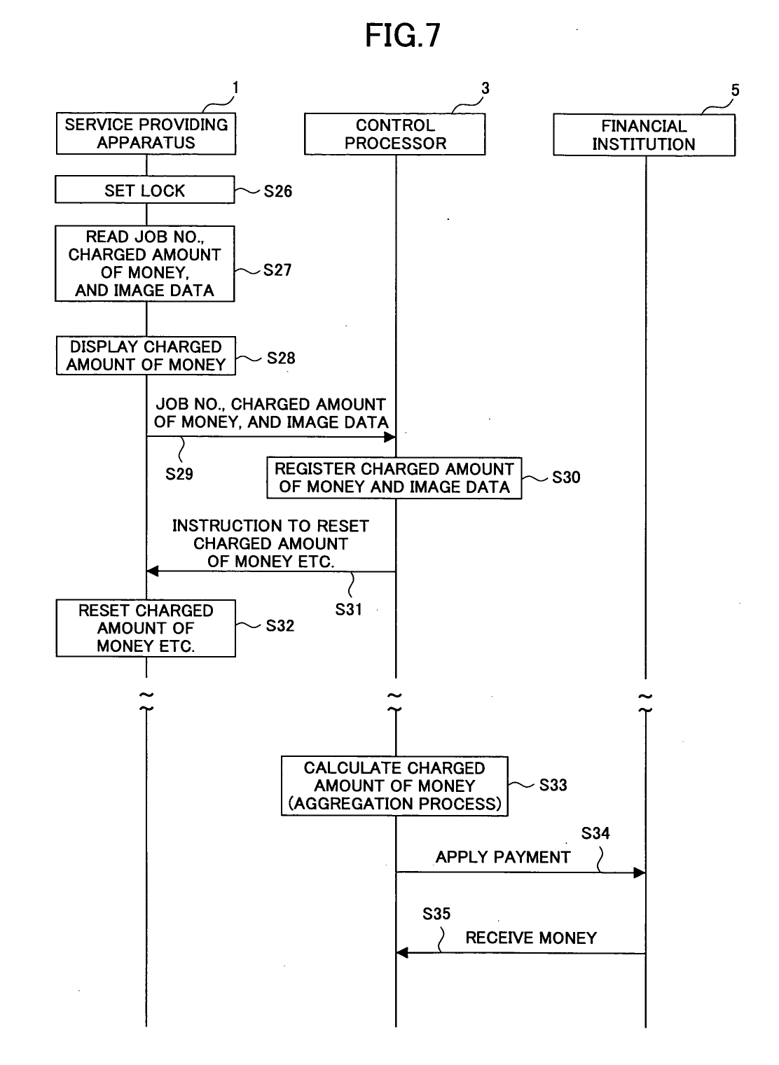

FIGS. 6 and 7 are sequence diagrams showing operations for providing a service in the first embodiment of the present invention, that is, processes (including charging processes) performed in the case where a user uses the service providing apparatus 1, which is a copying apparatus installed in a convenience store or the like.

Referring to FIG. 6, a description is given below of steps S11 through S25.

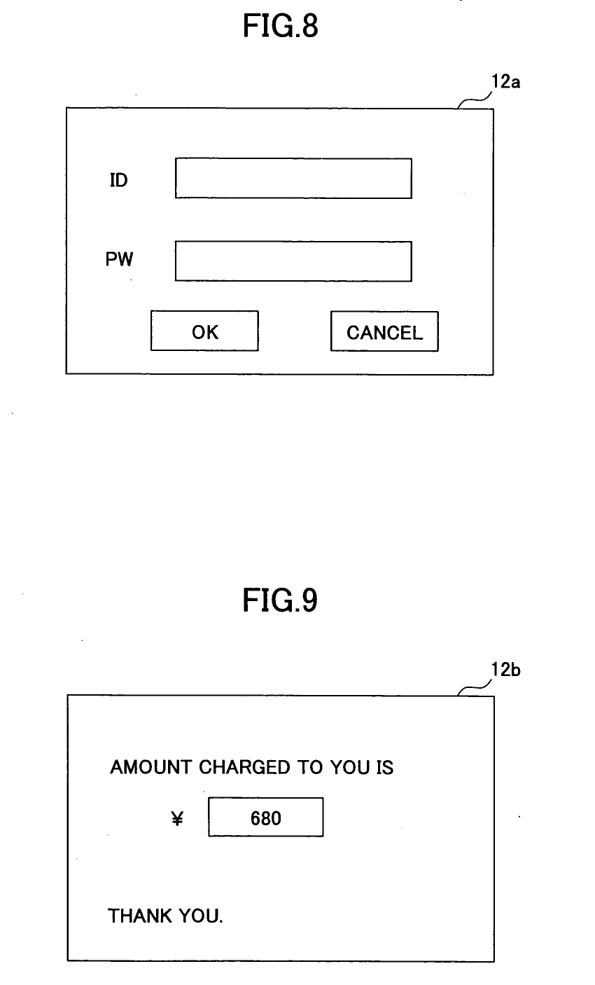

In step S11, the user selects charging via a network by using the operating part 13 in accordance with the contents displayed on the display part 12 of the service providing apparatus 1. Accordingly, as represented by a screen 12a shown in FIG. 8, the display part 12 of the service providing apparatus 1 displays frames for inputting a user ID and a user PW and soft buttons of “OK” and “cancel”. In addition, the display part 12 also displays a soft keyboard (not shown) for inputting, for example, characters.

In step S12, with the use of the soft keyboard and/or the ten-key pad of the operating part 13, the user inputs the user ID and the user PW that are provided in advance from the accounting service provider and, when there is no problem in the input contents, the user presses the OK button. Thereby, the user ID and the user PW are received in step S12.

In step S13, the service providing apparatus 1 transmits a usage request including the user ID and the user PW that are input by the user and the apparatus ID of the service providing apparatus 1 to the control processor 3, which is designated as a communications party. The usage request is information for asking the control processor 3 for usage of the service providing apparatus 1 by the user. Examples of such information include a user ID, a user PW, and a right ID (described below).

In step S14, upon reception of the usage request, the control processor 3 determines in the checking part 33 whether there is a match between the received apparatus ID and an apparatus ID stored in advance in the apparatus database DB3.

When there is a match (YES in step S14), in step S15, it is subsequently determined in the checking part 33 whether there is a match between the received user ID and user PW and a user ID and a user PW stored in advance in the user database DB1. When there is a match (YES in step S15), the control part 31 is notified of the match, and the subsequent process is performed by the job issuing part 34.

In step S16, in accordance with the result (usage permission) obtained from the checking part 33 that the apparatus ID, the user ID and the user PW match, the job issuing part 34 issues uniquely defined identification information (job number) during a predetermined period and notifies the control part 31 of the issued identification information.

In step S17, the job issuing part 34 associates the identification information (job number) with the user ID and the apparatus ID, and registers them in the accounting database DB2.

In step S18, the control part 31 sends the identification information (job number) issued by the job issuing part 34 and the notice of usage permission from the checking part 33 to the service providing apparatus 1 from the communication part 32 via the network 2 by assuming, as the destination, the network address of the service providing apparatus 1 obtained by referring to the apparatus database DB3 based on the apparatus ID of the service providing apparatus 1 that issues a charging request.

In the case where the notice of usage permission is issued (step S18), in step S20, the control part 11 of the service providing apparatus 1 temporarily stores in the storing part 14 the identification information (job number) in information from the control processor 3, and gives an instruction to the display part 12 in accordance with the notice of usage permission so as to display a message “Usage is permitted. Please use copying service.”, and thus the display part 12 displays the message.

Simultaneously, in step S21, the control part 11 of the service providing apparatus 1 releases the lock of the service process part 16 in accordance with the notice of usage permission, and resets (initializes) the charged amount of money temporarily stored in the storing part 14 to zero.

On the other hand, when there is no match in the checking of the apparatus ID and/or the user ID and the user PW (NO in step S14 and/or step S15, respectively), in step S19, the control part 31 sends a notice of usage not permitted to the service providing apparatus 1 via the network 2 from the communication part 32 in accordance with the result (usage not permitted) that there is no match in the apparatus ID or in the user ID and the user PW, which result is obtained from the checking part 33, by assuming, as the destination, the network address of the service providing apparatus 1 obtained by referring to the apparatus database DB3 based on the apparatus ID of the service providing apparatus 1 that issues the charging request.

In the case where the notice of usage not permitted is issued (step S19), the process proceeds to step S22. In step S22, the control part 11 of the service providing apparatus 1 gives an instruction to the display part 12 to display a message “Copy service cannot be provided. Please confirm user ID, etc . . . ” in accordance with the notice of usage not permitted, and the display part 12 displays the message. After step S22, the user may input, for example, the user ID again (step S12) or stop using the service providing apparatus 1.

In the case where the lock is released by the notice of usage permission (step S21), in step S23, the service providing apparatus 1 operates the service process part 16 every time the user requests a copying service. In step S24, the accounting process part 15 of the service providing apparatus 1 calculates the amount of money to be charged every time a process to be charged is performed, and adds the calculated amount of money to the charged amount of money temporarily stored in the storing part 14. The processes of steps S23 and S24 are repeated as long as the user is using the service providing apparatus 1.

When the user confirms that the user has enjoyed (completed using) the services from the service providing apparatus 1, in step S25, the user presses a complete button (provided in advance in the form of a soft key in the display part 12 or a hard key) of the operating part 13 to issue an end instruction, and the service providing apparatus 1 receives the end instruction.

Referring to FIG. 7, a description is given below of steps S26 through S35.

Upon reception of the end instruction via the complete button, in step S26, the control part 11 of the service providing apparatus 1 locks the service process part 16, which is unlocked, in accordance with the end instruction.

In step S27, the control part 11 reads from the storing part 14 the identification information (job number), the charged amount of money for the copying processes performed until the complete button is pressed (until the end instruction is issued), and image data subjected to the copying processes.

In step S28, as represented by a screen 12b shown in FIG. 9, the control part 11 gives an instruction to the display part 12 to present to the user the charged amount of money, which is the cost of the services (for example, copying processes), and the display part 12 displays the charged amount of money.

In step S29, the control part 11 sends, to the control processor 3 having a predetermined control processor address, information including the identification information (job number), the charged amount of money, and the image data.

Upon reception of the information from the service providing apparatus 1, in step S30, with the use of the accounting registration part 35, the control processor 3 refers to the accounting database DB2 based on the identification information (job number) in the information, records the charged amount of money to the item of “charged amount of money” of relevant identification information, and records the image data in the item of “content of processes”.

When recording of the charged amount of money and the like end, in step S31, the control processor 3 notifies the corresponding service providing apparatus 1 of the end of charging, and gives an instruction to the service providing apparatus 1 to delete the identification information (job number) and the image data and the like that are the content of processes generated at the time of copying, the identification information and the image data and the like being temporarily stored in the service providing apparatus 1, and reset (initialize) the charged amount of money to zero.

In step S32, based on the instruction in step S31, the control part 1 of the service providing apparatus 1 deletes the identification information (job number) temporarily stored in the storing part 14 and the image data and the like, and resets (initializes) the charged amount of money to zero.

On the other hand, in step S33, the accounting service provider operates the control processor 3 at predetermined intervals (for example, every month or every half year), thereby calculating the invoiced amount for the user. The accounting service provider applies for payment in step S34 to the financial institution designated by the user, and receives money in step S35.

It is assumable that the user uses various service providing apparatuses 1 at odd intervals. Hence, when calculating the invoiced amount (step S33), the “charged amount of money” is aggregated for each user (each user ID) from the accounting database DB2 by using the aggregation process part 36 of the control processor 3, thereby applying to the financial institution for payment. Since the accounting service provider uniquely defines the user ID for each user, it is possible to aggregate the charged amounts of money for each user by using the aggregation process part 36.

In addition, by using the aggregation process part 36, the accounting service provider aggregates the “charged amount of money” for each service providing apparatus 1 (each apparatus ID) from the accounting database DB2, and pays a commission at a predetermined rate to the shop (or company) where the service providing apparatus 1 corresponding to the apparatus ID is installed. Since the accounting service provider uniquely defines the apparatus ID for each service providing apparatus 1, it is possible to aggregate the charged amounts of money for each service providing apparatus 1 by using the aggregation process part 36.

A description is given below of a second embodiment of the present invention.

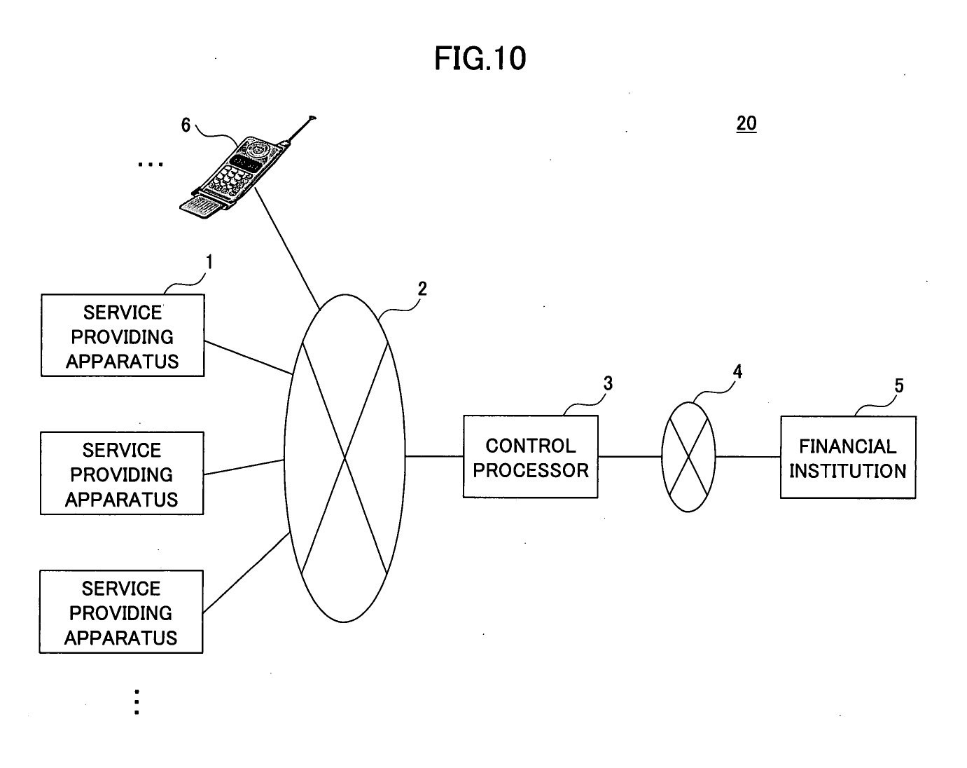

FIG. 10 is a block diagram of a service providing system 20 according to the second embodiment of the present invention. In FIG. 10, those parts that are the same as those corresponding parts in FIG. 1 are designated by the same reference numerals, and a description thereof is omitted.

Referring to the service providing system 20 shown in FIG. 10, a user has a mobile terminal 6, which is not provided in the service providing system 10 shown in FIG. 1. The user can send information to and receive information from the control processor 3 via the network 2. In the other respects, the service providing system 20 is the same as the service providing system 10. It should be noted that the mobile terminal 6 is an information processing terminal that can be carried by a user, for example: a PDA, a laptop personal computer, and a mobile phone. Additionally, instead of the mobile terminal 6, a desktop personal computer or a terminal including a mobile terminal, for example, may be used.

The structure of the service providing apparatus 1 according to the second embodiment is the same as that according to the first embodiment shown in FIG. 2. The service providing apparatus 1 according to the second embodiment and that according to the first embodiment differ only in their operations, which differences are described below.

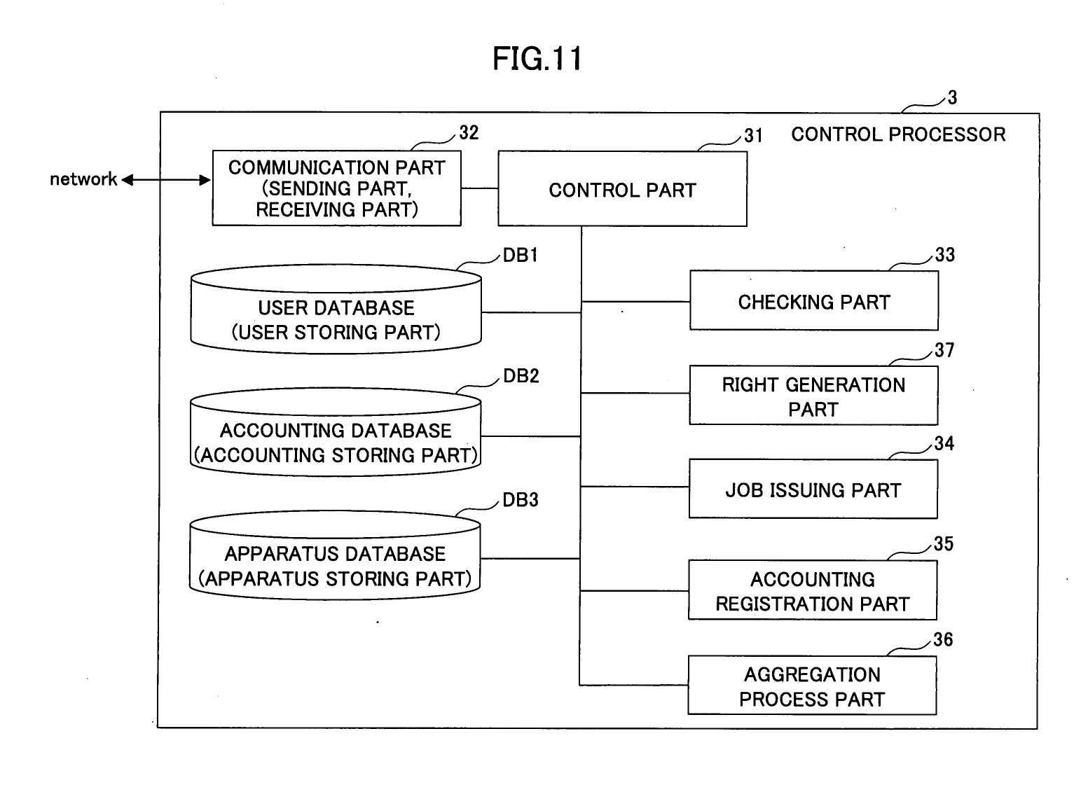

FIG. 11 is a block diagram of the control processor 3 according to the second embodiment of the present invention.

Referring to FIG. 11, the control processor 3 includes the control part 31, the communication part 32, the checking part 33, the job issuing part 34, the accounting registration part 35, the aggregation process part 36, a right generation part 37, the user database DB1, the accounting database DB2, and the apparatus database DB3. In the control processor 3 according to the second embodiment shown in FIG. 11, the right generation part 37 is provided in addition to the components of the control processor 3 according to the first embodiment shown in FIG. 3.

Hereinafter, the second embodiment is explained with a focus on those aspects that are different from the first embodiment.

The control part 31 includes a function to control processes performed by the control processor 3.

The communication part 32 includes functions (a sending function and a receiving function) to send various information items to and receive various information items from the mobile terminal 6 in addition to the service providing apparatuses 1 via the network 2.

The checking part 33 includes functions to give an instruction to the mobile terminal 6 as to whether to permit issuance of a qualification and give an instruction to the service providing apparatus 1 as to whether to permit usage thereof. In the narrow sense, the checking part 33 includes a function to check, for example: users to be charged, the service providing apparatuses 1, and the right ID representing the qualification for enjoying (using) a service. More specifically, the checking part 33 performs, for example, the following processes.

(1) The checking part 33 performs processes of receiving a request for right (the right includes, for example, the user ID and the user PW (password) of the user) sent from the mobile terminal 6 that the user has, and determining whether the user ID and the user PW match the corresponding user ID and user PW in the user database DB1, which stores the user information with respect to users in advance. When there is a match, the checking part 33 notifies the control part 31 of “issuance of a qualification is permitted”. When there is no match, the checking part 33 notifies the control part 33 that “issuance of a qualification is not permitted”. Here, the request for right is information for asking the control processor 3 for a qualification to use the service providing apparatus 1. Examples of such information include information for simply obtaining issuance of a qualification and information of a user ID uniquely defined for a user.

(2) The checking part 33 performs processes of receiving an apparatus ID in the information sent from the service providing apparatus 1, and determining whether a corresponding apparatus ID exists by referring to the apparatus database DB3, which stores in advance information related to the service providing apparatuses 1. When the decision result is “YES” (when the corresponding apparatus ID exists), the process proceeds to the following step (3). When the decision result is “NO” (when the corresponding apparatus ID does not exist), the checking part 33 notifies the control part 31 of “usage not permitted”. It should be noted that the checking of an apparatus ID is not always necessary. The checking of an apparatus ID is applied when it is determined in advance whether the service providing apparatus 1 is chargeable via the network 2.

(3) The checking part 33 receives the right ID included in the information sent from the service providing apparatus 1, and determines whether there is a match between the received right ID, which is generated in advance with respect to the user, and the right ID temporarily stored in the user database DB1. When there is a match, by further referring to the user database DB1, the checking part 33 determines whether an accounting flag corresponding to the right ID is ON. When the accounting flag is OFF, the checking part 33 notifies the control part 31 that “usage is permitted”. On the other hand, when there is no match or when the accounting flag is ON (representing that the right ID is chargeable (a charging target)) even if there is a match, the checking part 33 notifies the control part 31 “usage not permitted”.

The right generation part 37 includes a function to generate a right ID, which represents a qualification to use the service providing apparatus 1. Here, the right ID is information indicating a qualification to use the service providing apparatus 1, which qualification is issued (generated) in accordance with a request for right. More preferably, the right ID is information indicating a disposable single-use qualification. This is because, if the right ID can be used plural times, it becomes very difficult to prevent unauthorized leakage of the right ID. Accordingly, by allowing usage of the right ID only once, it is possible to reduce unauthorized use of the service providing apparatus 1 and to easily provide temporary service. In addition, it becomes unnecessary to carelessly input personal information such as a user ID to the service providing apparatus 1, which is used by the general public. Thus, it is possible to increase security.

The job issuing part 34 notifies the control part 31 of the issued identification information (job number) and performs a process of storing in the accounting database DB2 the identification information (job number) in association with the user ID and the apparatus ID. The job issuing part 34 refers to the user database DB1 based on the user ID, and puts ON the accounting flag corresponding to the right ID related to the user ID. With respect to the other functions, the job issuing part 34 according to the second embodiment is the same as that according to the first embodiment.

The accounting registration part 35 according to the second embodiment is the same as that according to the first embodiment.

The aggregation process part 36 according to the second embodiment is the same as that according to the first embodiment.

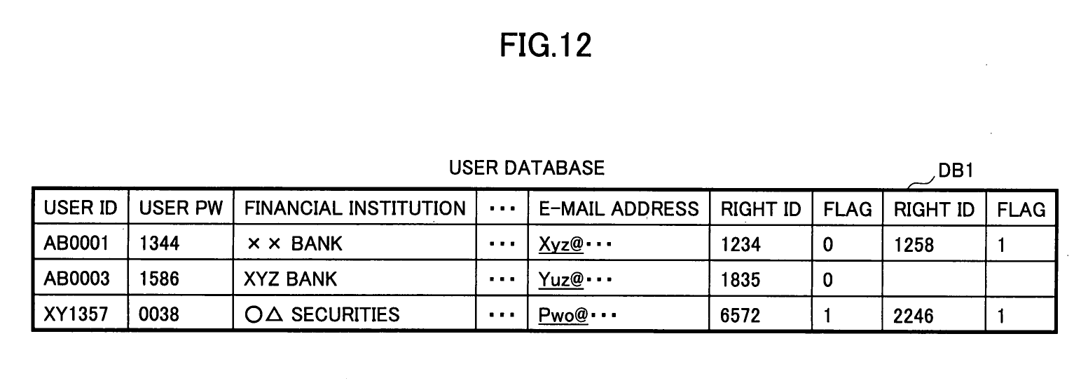

The user database DB1, which serves as a user storing part, stores user information related to users. As shown in FIG. 12, the user database DB1 includes items of at least user ID, user PW (password), financial instrument via which fee is paid (for example, account), a right ID, and accounting flag corresponding to the right ID. In addition to these, the user database DB1 may also include items of, for example, address of user, name, age, occupation, telephone number (fixed telephone), telephone number (mobile phone), and e-mail address.

Here, the right ID is information indicating a qualification to use the service providing apparatus 1. The accounting flag is a parameter indicating whether the right ID is chargeable at the present moment. That is, when the accounting flag is ON (“1”), it is indicated that the right ID is chargeable at the present moment, and when the accounting flag is OFF (“0”), it is indicated that the right ID is not chargeable at the present moment.

The accounting database DB2 and the apparatus database DB3 according to the second embodiment, serving as an accounting storing part and an apparatus storing part, respectively, are the same as those according to the first embodiment.

Next, a description is given below of operations in the second embodiment of the present invention. Here, it is assumed that the mobile terminal 6 is a mobile phone installed with a browser and the service providing apparatus 1 is a copying apparatus.

As for registration of a user, since processes thereof are the same as those in the first embodiment shown in FIG. 5, a description thereof is omitted.

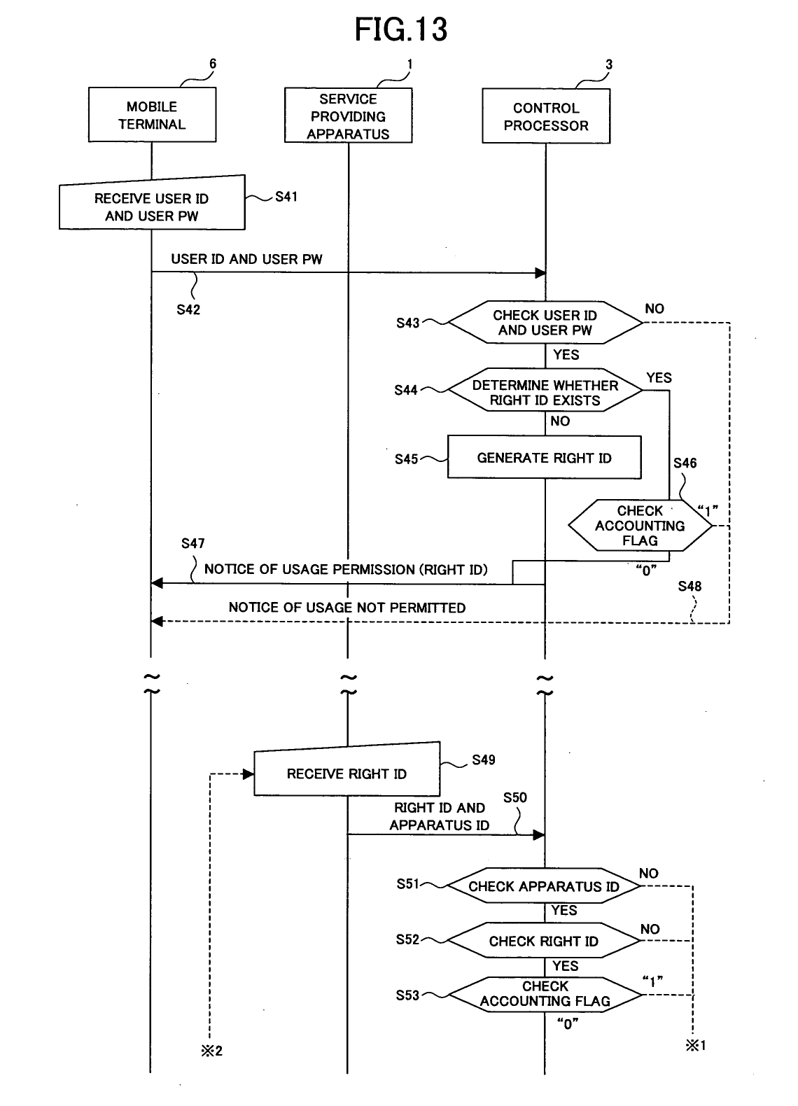

FIG. 13 through 15 are sequence diagrams showing operations for providing a service in the second embodiment of the present invention, that is, processes (including charging processes) performed in the case where a user uses the service providing apparatus 1, which is a copying apparatus, installed in a convenience store or the like.

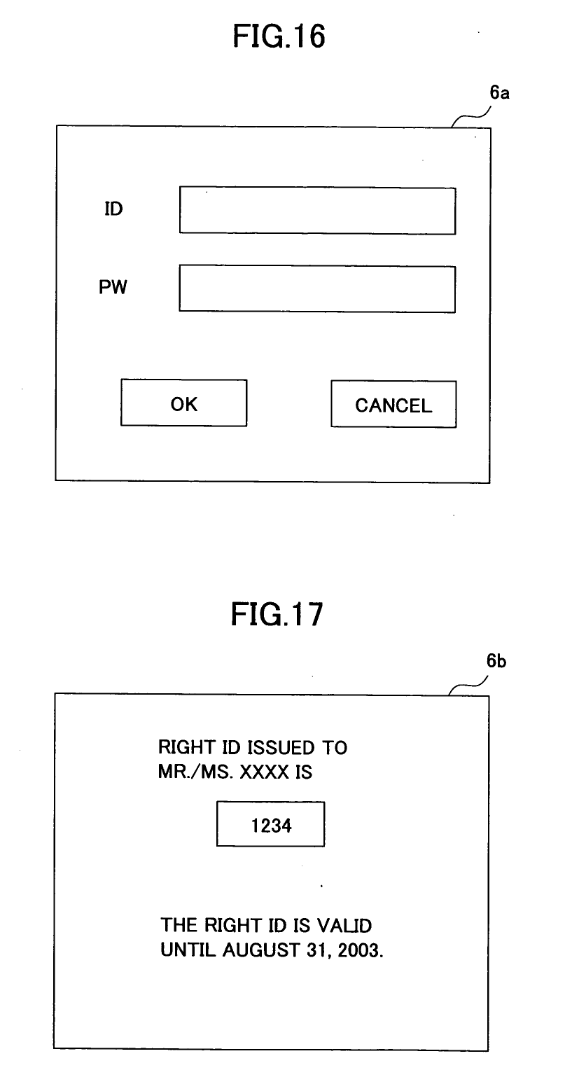

First, using the mobile terminal 6 that the user possesses, the user starts a browser by a predetermined operation and establishes a connection with the control processor 3 via a WWW site administered by the accounting service provider via the network 2. By establishing a connection with the control processor 3, the display part of the mobile terminal 6 displays frames for inputting a user ID and a user PW as represented by a screen 6a shown in FIG. 16.

Referring to FIG. 13, a description is given below of steps S41 through S53.

The user operates the mobile terminal 6 to input the user ID and the user PW that are provided in advance from the accounting service provider. Then, if there is no problem in the input contents, the user presses the OK button. Thereby, the user ID and the user PW are received by the mobile terminal 6 in step S41.

In step S42, the mobile terminal 6 sends, to the control processor 3 coupled thereto, the user ID and the user PW that are input by the user.

When the control processor 3 receives the information (including the user ID and the user PW), it is determined by the checking part 33 in step S43 whether the received user ID and user PW match a user ID and a user PW stored in the user database DB1 in advance.

When there is a match (YES in step S43), it is subsequently determined by the checking part 33 in step S44 whether there is a right ID associated with the user ID.

When such a right ID does not exist (NO in step S44), in accordance with the result obtained from the checking part 33, i.e., the result that there is a match in the user IDs, etc., and a right ID is not yet issued, in step S45, the right generation part 37 generates a right ID and notifies the control part 31 of the generated right ID. Then, the right generation part 37 records the generated right ID in the column of right ID associated with the user ID in the user database DB1.

On the other hand, when the right ID exists (YES in step S44), it is determined by the checking part 33 in step S46 whether the accounting flag associated with the right ID is ON.

After generating the new right ID (step S45), or when it is determined that the accounting flag associated with the existing right ID is OFF (“0”) (step S46), the process proceeds to step S47. In step S47, the control part 31 displays on the browser of the mobile terminal 6 the right ID newly generated in the right generation part 37 or a right ID that exists in the user database DB1 but remains unused (not chargeable). Alternatively, in step S47, the control part 31 obtains an e-mail address of the user by referring to the user database DB1 based on the user ID, and provides the right ID by using an e-mail addressed to the obtained e-mail address. FIG. 17 shows a screen 6b displaying the right ID in the mobile terminal 6.

On the other hand, when there is no match in the user ID and the user PW (step S43), or when it is determined that the accounting flag associated with the existing right ID is ON (“1”) (step S46), the process proceeds to step S48. In step S48, in accordance with the result obtained from the checking part 33, i.e., the result that the user IDs, etc., do not match or the result that the right ID is already set to be chargeable, the control part 31 displays on the browser of the mobile terminal 6 that there is no qualification to use the service providing apparatus 1. Alternatively, in step S48, the control part 31 obtains an e-mail address of the user by referring to the user database DB1 based on the user ID, and gives a notice that there is no qualification (no permission) to use the service providing apparatus 1 in an e-mail addressed to the obtained e-mail address. The user who receives the notice of usage not permitted may input, for example, the user ID again or stop using the service providing apparatus 1.

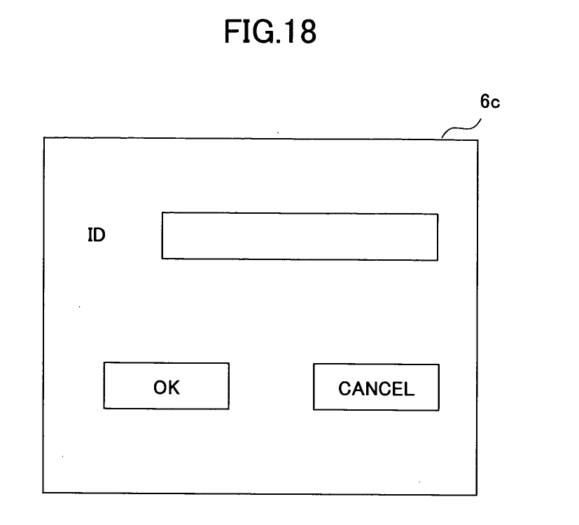

When the user is informed of the right ID (step S47), the user inputs the right ID provided from the control processor 3 to the service providing apparatus 1. When there is no problem in the input contents, the user presses an OK button. Thereby, the right ID is received in step S49. FIG. 18 shows a screen 6c where the right ID is input.

Upon reception of the right ID that is input by the user, the service providing apparatus 1 sends in step S50 the right ID and the apparatus ID to the control processor 3.

When the control processor 3 receives the information (including the right ID and the apparatus ID), it is determined by the checking part 33 in step S51 whether the apparatus ID in the received information matches an apparatus ID stored in advance in the apparatus database DB3.

When there is a match in the apparatus IDs (YES in step S51), it is subsequently determined by the checking part 33 in step S52 whether the right ID in the received information matches a right ID in the user database DB1.

When there is a match in the right IDs (YES in step S52), it is determined by the checking part 33 in step S53 whether the accounting flag is ON (“1”) with respect to the right ID in the received information.

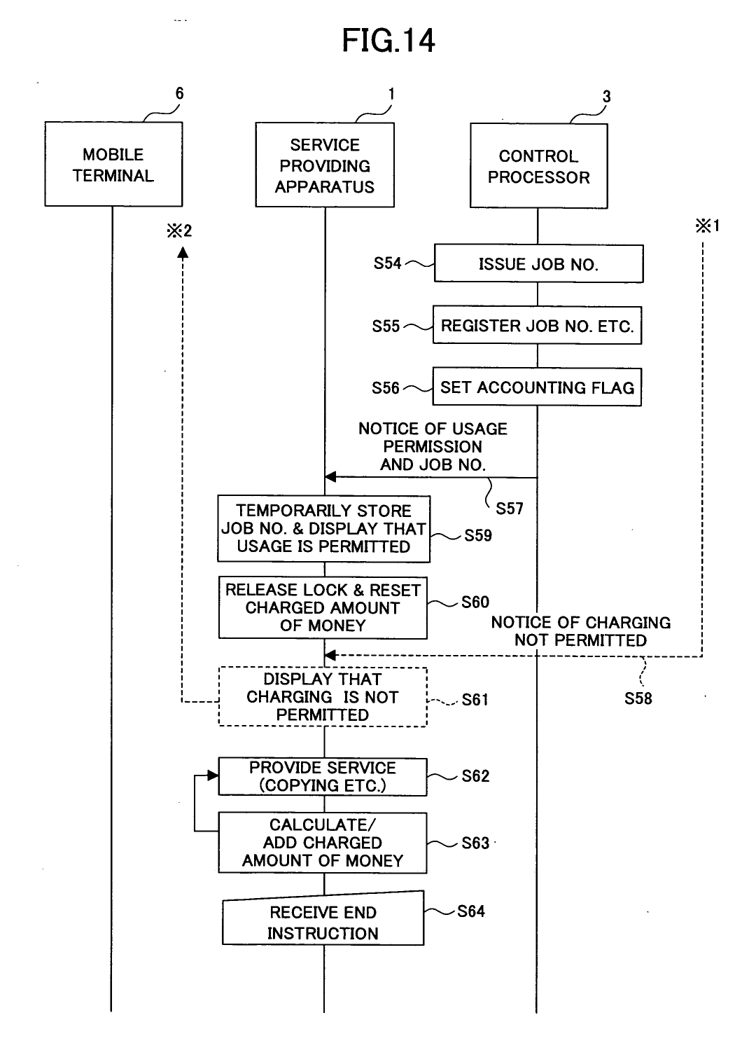

Referring to FIG. 14, a description is given below of steps S54 through S64.

When the accounting flag is OFF (“0”), in accordance with the result obtained from the checking part 33, i.e., the result that the right ID is unused, the job issuing part 34 issues in step S54 identification information (job number) uniquely defined in a predetermined period and notifies the control part 31 of the issued identification information. In step S55, the job issuing part 34 registers in the accounting database DB2 the identification information (job number), the user ID, and the apparatus ID. In step S56, the job issuing part 34 sets ON the accounting flag associated with the right ID.

In step S57, the control part 31 sends from the communication part 32 thereof to the service providing apparatus 1 via the network 2 the identification information (job number) issued in the job issuing part 34 and the notice of usage permission by assuming, as a destination, the network address of the service providing apparatus 1 obtained by referring to the apparatus database DB3 based on the apparatus ID of the service providing apparatus 1 that issues the request for charging.

When the notice of usage permission is issued (step S57), the control part 11 of the service providing apparatus 1 causes the storing part 14 to temporarily store the identification information (job number) included in the information sent from the control processor 3, and gives an instruction to the display part 12 to display a message “Charging is permitted. Please use copying service.” in accordance with the notice of usage permission, and the message is displayed on the display part 12.

Simultaneously, in step S60, the control part 11 of the service providing apparatus 1 releases the lock of the service process part 16 in accordance with the notice of usage permission, and resets (initializes) the charged amount of money that is temporarily stored in the storing part 14 to zero.

On the other hand, when there is no match in the apparatus IDs (NO in step S51) or in the right IDs (NO in step S52), or when it is determined that the accounting flag is ON (“1” in step S53), the process proceeds to step S58. In step S58, in accordance with the result obtained from the checking part 33, i.e., the result that the apparatus IDs or the right IDs do not match or the result that the right ID is already used (in use), the control part 31 sends from the communication part 32 to the service providing apparatus 1 via the network 2 a notice of charging not permitted by assuming, as the destination, the network address of the service providing apparatus 1 obtained by referring to the apparatus database 3 based on the apparatus ID of the service providing apparatus 1 that issues the request for charging.

When the notice of charging not permitted is issued (step S58), the process proceeds to step S61. In step S61, in accordance with the notice of charging not permitted, the control part 11 of the service providing apparatus 1 gives an instruction to the display part 12 to display a message “Charging is not permitted. Please confirm the right ID again.”, and the message is displayed on the display part 12 in step S61. After step S61, the user may input the right ID again in step S49 or stop using the service providing apparatus 1.

When the lock is released under the notice of usage permission (step S60), the service providing apparatus 1 operates in step S62 the service process part 16 every time the user requests a copying service. Every time the service process part 16 is operated, in step S63, the accounting process part 15 of the service providing apparatus 1 calculates the amount of money to be charged, and adds the calculated amount of money to the charged amount of money temporarily stored in the storing part 14. Steps S62 and S63 are repeated as long as the user is using the service providing apparatus 1.

Then, when the user confirms that the user has enjoyed the services from the service providing apparatus 1, the user presses the complete button (provided in the form of a soft key in the display part 12 or in the form of a hard key) of the operating part 13 to issue an end instruction, and the service providing apparatus 1 receives the end instruction in step S64.

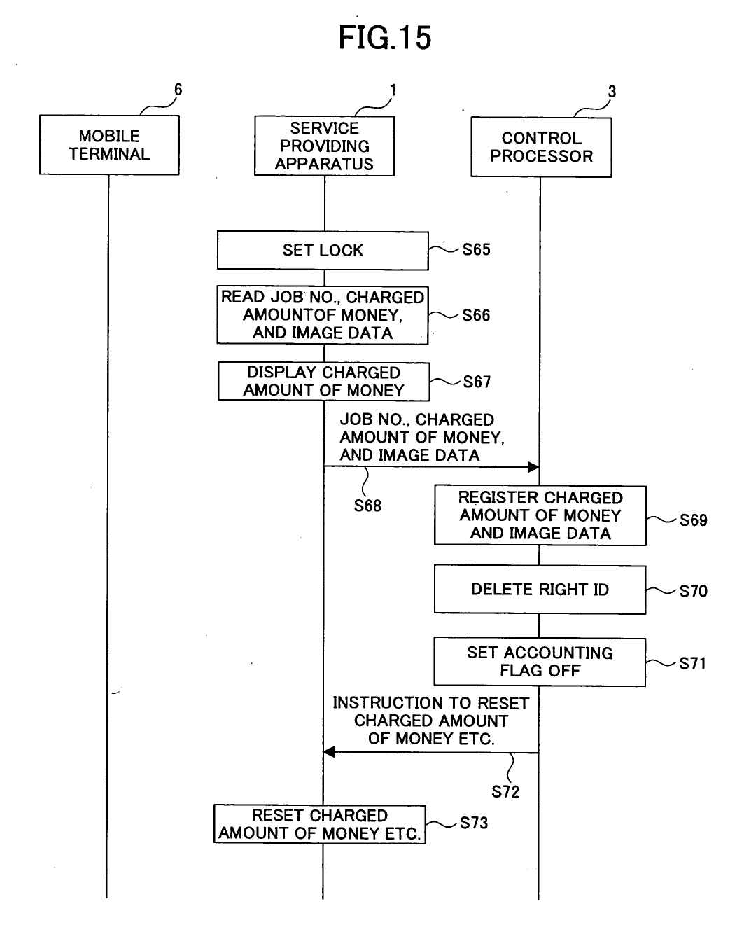

Referring to FIG. 15, a description is given below of steps S65 through S73.

Upon reception of the end instruction via the complete button, in step S65, the control part 11 of the service providing apparatus 1 locks the service process part 16 in accordance with the end instruction.

In step S66, the control part 11 reads from the storing part 14 the identification information (job number) stored in the service providing apparatus 1, the charged amount of money for the copying processes performed until the complete button is pressed (until the end instruction is given), and image data, which are the content of processes subjected to the copying processes.

In step S67, the control part 11 gives an instruction to the display part 12 to display to the user the charged amount of money, which is the cost for the copying processes, and the charged amount of money is displayed on the display part 12.

In step S68, the control part 11 sends information including the identification information (job number), the charged amount of money, and the image data to the control processor 3 having a predetermined control processor address.

Upon reception of the information from the service providing apparatus 1, the process proceeds to step S69. In step S69, by using the accounting registration part 35, the control processor 3 refers to the accounting database DB2 based on the identification information (job number) included in the information, records the charged amount of money in the item of “charged amount of money” associated with the identification information, and records the image data in the item of “content of processes”.

In step S70, the control processor 3 refers to the accounting database DB2 based on the identification information (job number), thereby reading the user ID. Also, the control processor 3 refers to the user database DB1 based on the read user ID, and deletes the stored right ID associated with the user ID. In step S71, the control processor 3 sets OFF the accounting flag associated with the deleted right ID.

At the end of the processes of deleting the right ID (step S70) and setting OFF the accounting flag (step S71), the process proceeds to step S72. In step S72, the control processor 3 notifies the relevant service providing apparatus 1 that the accounting ends, deletes the identification information (job number) temporarily stored in the service providing apparatus 1 and the image data or the like that are the content of processes generated at the time of copying, and issues an instruction to reset (initializes) the charged amount of money to zero.

In step S73, based on the instruction, the control part 11 of the service providing apparatus 1 deletes the identification information (job number) temporarily stored in the storing part 14, image data, and the like, and resets (initializes) the charged amount of money to zero. Hereupon, the series of processes performed when using the service providing apparatus ends.

A description is given below of other features of the present invention.

First, a description is given below of presentation of accounting information with respect to users.

The accounting service provider can disclose to, for example, users the history showing how users have used the service providing apparatus 1. The processes performed in such a case are as follows.

(1) A user establishes a connection with the control processor 3 via the network 2 with the use of, for example, the mobile terminal 6. The control processor 3 prompts the user to input his/her user ID and user PW, and the user inputs his/her user ID and user PW.

(2) The control part 31 of the control processor 3 causes the checking part 33 to determine whether the received user ID, etc., match a user ID, etc., stored in advance in the user database DB1. When there is no match, the control part 31 of the control processor 3 causes the mobile terminal 6 to show an error display.

(3) When there is a match in the user IDs, etc., the control part 31 of the control processor 3 causes the aggregation process part 36 to refer to the accounting database DB2, the aggregation process part 36 performs aggregation by the received user ID, and the control part 31 causes the mobile terminal 6 of the user to display only accounting information of the relevant user ID.

(4) The user can refer to the items such as the “charged amount of money” and the “content of processes” of the displayed accounting information by operating, for example, the mobile terminal 6. In addition, on this occasion, the control processor 3 may add up and display the “charged amount of money” of a specified user ID.

(5) When the user confirms a “location of use”, the control part 31 of the control processor 3 can refer to the apparatus database DB3 based on the apparatus ID that is stored in association with the identification information (job number) in the accounting database DB2 so as to extract, for example, an installation location and display, for example, the “location of use” on the mobile terminal 6 of the user.

In addition, when presenting accounting information to a user, in the case where the user is a company or a company employee, the following processes may be performed.

In the case where a user is a company, it is possible to perform management for each company by issuing a user ID, etc., for each employee of the company and manage user IDs, etc., issued to employees of the company with the user database DB1. Particularly, the item of company code, which uniquely defines a company, may be provided in the user database DB1 and the accounting database DB2. Additionally, in the case where money is managed for each company, by performing aggregation by a company code with respect to the accounting database DB2 with the use of the aggregation process part 36, it is possible to find the total cost for the company that is specified by the company code and charge the company at one time. Furthermore, by further performing aggregation by a user ID after performing aggregation by the company code, it is possible to find the amount of money used by each employee of the company.

Next, a description is given below of a process to change the payment method for each user.

According to the present invention, it is possible to differentiate in advance the calculation of the fee for each company. Particularly, there are two methods as follows.

(First Method)

The control processor 3 additionally includes a value determination part, and the user database DB1 includes an identification code that indicates a table or an equation for calculating the value for the user ID of each user.

The value determination part stores a plurality of “tables and/or equations for calculating fees” and “identification codes” for distinguishing each of the tables and/or equations. The value determination part refers to the user database DB1 based on a user ID or a right ID sent from the service providing apparatus 1 so as to read the identification code that indicates the table and/or equation for calculating the fee with respect to the relevant user.

The value determination part determines the table and/or equation for calculating the fee with respect to the identification code. The value determination part sends to the service providing apparatus 1 a notice of usage permission and the read table and/or equation for calculation.

The accounting process part 15 of the service providing apparatus 1 stores (sets) the tables and/or equations for calculating fees that are referred to at the time of charging, and uses the tables and/or equations when providing services to users.

(Second Method)

The user database DB1 of the control processor 3 includes the item of identification code that indicates a table and/or equation for calculating the fee for each user ID. In addition, the accounting process part 15 of the service providing apparatus 1 additionally stores a plurality of tables and/or equations for calculating fees and the identification codes for distinguishing each of the tables and/or equations.

The service providing apparatus 1 stores in advance in the storing part 14 the identification codes and the “tables and/or equations for calculating fees” corresponding to the identification codes.

The control processor 3 refers to the user database DB1 based on a user ID or a right ID sent from the service providing apparatus 1, thereby reading the identification code indicating the table or equation for calculating the fee for the relevant user. The control processor 3 sends to the relevant service providing apparatus 1 a notice of usage permission together with the read identification code.

Based on the received identification code, the accounting process part 15 of the service providing apparatus 1 updates the table or equation for calculating the fee to be referred to, and uses the updated table and/or equation in order to calculate the fee for providing a service with respect to the user.

The present invention is not limited to the specifically disclosed embodiments and drawings, and variations and modifications may be made without departing from the scope of the present invention.

The present application is based on Japanese Priority Application No. 2003-352243 filed on Oct. 10, 2003, the entire contents of which are hereby incorporated by reference.

1. A service providing apparatus, comprising:
an operating part that receives a usage request from outside;
a sending part that sends the usage request to a control processor via a network;
a receiving part that receives usage permission corresponding to the usage request from the control processor via the network; and
a service process part that is enabled based on the usage permission and disabled upon reception of a predetermined end instruction.

2. The service providing apparatus as claimed in claim 1, further comprising:
a storing part that stores a charged amount of money; and
an accounting process part that starts calculation of a fee with respect to a service provided based on the usage permission and adds the calculated fee to the charged amount of money in the storing part;
wherein, upon reception of the predetermined end instruction, the sending part sends to the control processor the charged amount of money stored in the storing part.

3. The service providing apparatus as claimed in claim 2,
wherein the receiving part receives, from the control processor, identification information uniquely defined for each operation,
the storing part stores the identification information in association with the charged amount of money, and,
upon reception of the end instruction, the sending part sends to the control processor the identification information and the charged amount of money stored in the storing part.

4. The service providing apparatus as claimed in claim 1, wherein the usage request is one of: a pair of a user ID and a user PW that are set in advance for each user; and a right ID indicating a qualification to use the service providing apparatus.

5. A control processor, comprising:
a receiving part that receives a usage request from a service providing apparatus via a network;
a checking part that issues usage permission corresponding to the usage request; and
a sending part that sends the usage permission to the service providing apparatus via the network.

6. The control processor as claimed in claim 5, further comprising:
a right generation part that generates for a user a right ID indicating a qualification to use the service providing apparatus;
wherein the receiving part receives a right request for using the service providing apparatus from a terminal used by the user via the network,
the right generation part generates the right ID corresponding to the right request, and
the sending part sends the right ID to the terminal via the network.

7. The control processor as claimed in claim 5, further comprising:
an accounting storing part that stores accounting information; and
an accounting registration part that stores a charged amount of money in the accounting information of the accounting storing part,
wherein the receiving part receives, from the service providing apparatus via the network, the charged amount of money that is a value for using the service providing apparatus.

8. The control processor as claimed in claim 7, further comprising:
a job issuing part that issues identification information uniquely defined for each operation and stores the identification information in the accounting storing part in association with the accounting information;
wherein the sending part sends the identification information to the service providing apparatus via the network,
the receiving part receives the identification information and the charged amount of money from the service providing apparatus via the network, and,
based on the identification information, the accounting registration part stores the charged amount of money in the accounting information associated with the identification information.

9. The control processor as claimed in claim 5, wherein the usage request is one of: a pair of a user ID and a user PW that are set in advance for each user; and
a right ID indicating a qualification to use the service providing apparatus.

10. The control processor as claimed in claim 5, wherein the checking part determines whether the usage request received by the receiving part is valid and, when the usage request is valid, issues the usage permission of the service providing apparatus.

11. The control processor as claimed in claim 5, further comprising:
an aggregation process part that performs aggregation by one of items of a user, a company to which the user belongs, and the service providing apparatus.

12. A service providing method of providing a service to a user by controlling a service providing apparatus, said method comprising the steps of:
receiving one of a usage request and an end instruction from outside;
sending the usage request to a control processor via a network;
receiving usage permission from the control processor via the network; and
allowing use of the service providing apparatus based on the usage permission and making use of the service providing apparatus impossible based on the end instruction.
